(19) United States
(12) Patent Application Publication
(10) Pub. No.: US 2015/0182300 A1
(43) Pub. Date: Jul. 2, 2015

(54) DENTAL FILING STRIP SYSTEM

(71) Applicant: DANIEL SUNG-YUL KIM, VANCOUVER, WA (US)

(72) Inventor: DANIEL SUNG-YUL KIM, VANCOUVER, WA (US)

(21) Appl. No.: 14/555,456

(22) Filed: Nov. 26, 2014

Related U.S. Application Data
(63) Continuation-in-part of application No. 14/048,695, filed on Oct. 8, 2013, now Pat. No. 8,932,057.
Application No. 14/048,695 is a continuation-in-part of application No. 13/715,733, filed on Dec. 14, 2012, now Pat. No. 8,602,778.
(60) Provisional application No. 61/639,804, filed on Apr. 27, 2012.

(51) Int. Cl. A61C 3/06

(52) U.S. Cl. CPC A61C 3/06

(57) ABSTRACT

A dental filing strip system includes a base metal strip having opposite surfaces, adhering layers applied to either or both base metal strip surfaces, and abrasive particle layers adhered to either or both base metal strip surfaces by the respective adhering layers, wherein the abrasive particle layers are composed of abrasive particles having nominal average particle sizes not greater than approximately 0.035 mm. The dental filing strip system includes a plurality of filing strips of incremental thicknesses, wherein the particle sizes are maintained not greater than approximately 0.035 mm but the base metal strip thicknesses are selectively modified, to obtain greater overall thicknesses without requiring larger particle sizes. The dental filing strip system may provide free ends, or may have the filing strip ends couple to a handle.

### CROSS-REFERENCE TO RELATED APPLICATIONS

This application is a continuation-in-part of, and claims priority to, co-pending U.S. patent application Ser. No. 14/048,695, filed Oct. 8, 2013, which is a continuation in part of U.S. patent application Ser. No. 13/715,733, filed Dec. 14, 2012. Application Ser. No. 13/715,733 is a nonprovisional application of, and claims priority to, U.S. Provisional Application Ser. No. 61/639,804, filed Apr. 27, 2012, the disclosures of each of which are hereby incorporated by reference.

### FIELD OF THE INVENTION

The present invention relates to dental filing tools. More particularly, the present invention relates to improved dental filing strips having approximately constant thickness abrasive layers, but varied base metal strip thicknesses.

### BACKGROUND

The current conventional method for fitting dental crowns, bridges, onlays and inlays, herein referred to generally as restorations, involves the dental practitioner sliding colored carbon paper, of which the thickness is the recommended measured distance between teeth, between the interproximal area of the tooth and the restoration. The carbon paper marks with carbon ink the proximal contact area where the two surfaces of the teeth and/or restoration are too close, and then the practitioner grinds the restoration with a rotary instrument to remove excess material.

Another method employed is the use of a metal filing strip coated with some superfine abrasive material. The metal filing strip is inserted into the interproximal area to file down the proximal contact area of the crown for an accurate fit. Since the space between the tooth and the crown, bridge, onlay, and inlay must not be too close or too spaced apart the practitioner must file incrementally. These steps are repeated until the desired distance between the tooth and the restoration is achieved.

Another method employed is that a thin metal strip coated with fine abrasive material is embedded within a arcuate handle, or fastened to a removable bow which is attached an extending handle.

All of the apparatus and methods employing thin abrasive strips have a common limitation, however, which limits their optimization. Referring to Fig. xxx, a typical existing system is shown. Generally, abrasive strips used in such dental procedures consist of a thin strip of stainless steel or titanium base metal, typically approximately 0.25 mm thickness, to which a layer of abrasive particles is adhered, for example embedded within a thin (10 um) layer of electroplated nickel. Typically, the abrasive layer consists of diamond particles having a given nominal average size. The overall thickness of the abrasive strip constitutes the sum of the base metal strip thickness, the electroplate substrate, and the average particle cross section thickness. Therefore, obtaining a thicker overall strip imposes the limitation of using correspondingly larger particle sizes, because the current state of the art is that, in order to obtain a greater overall thickness abrasive strip, the abrasive particle size is increased, while the base metal thickness remains essentially unchanged. This limitation creates significant disadvantages. Importantly, larger-sized abrasive particle layers, although effective at removing unwanted material, are less effective at polishing, and leave undesirable scratches on the enamel surface, and in some circumstances can cause significant linear grooves on the enamel surface. This is undesirable because it is aesthetically not optimal, leaving a less polished surface which require substantial additional polishing, using strips with progressively finer particle sizes (and thereby removing additional enamel), to achieve higher polish. If the grooves are left without further polishing, then they may provide undesirable breeding surfaces for bacteria and/or cause buildup of plaque and other staining/discoloring matter. The inventor has found that abrasive strips having average particle size greater than approximately 25-35 um will leave undesirable grooving and/or scratches which require substantial additional polishing effort to remove.

There are situations where a practitioner requires a thicker abrasive strip to correspond to a required interproximal clearance, but it would be undesirable to use a greater particle size. The thicker strip would initially achieve the optimum interproximal clearance, but the required further polishing would then increase the interproximal clearance beyond the required or optimal clearance.

The present invention solves these problems by providing an improved filing strip system, wherein the average abrasive particle size is maintained approximately 35 um or less, but the base metal strip thickness is varied to match a desired interproximal clearance, in order to eliminate or reduce additional interproximal surface polishing requirements. The improved filing strips are useful for hand-held methods, as well as in combination with handle-mounted apparatus and power driven apparatus.

### SUMMARY AND ADVANTAGES

A dental filing strip system includes a base metal strip having opposite surfaces, adhering layers applied to either or both base metal strip surfaces, and abrasive particle layers adhered to either or both base metal strip surfaces by the respective adhering layers, wherein the abrasive particle layers are composed of abrasive particles having nominal average particle sizes not greater than approximately 0.035 mm. The dental filing strip system includes a plurality of filing strips of incremental thicknesses, wherein the particle sizes are maintained not greater than approximately 0.035 mm but the base metal strip thicknesses are selectively modified, to obtain greater overall thicknesses without requiring larger particle sizes. The dental filing strip system may provide free ends, or may have the filing strip ends coupled to a handle.

The dental filing strip system presents numerous advantages, including: (1) provides ability to select a filing strip thickness determined by a desired interproximal clearance; (2) provides for a incrementally greater thicknesses, but while maintaining a fine grit size for the abrasive particles, thereby avoiding excessively deep scratches; (3) avoids need for excessive re-polishing, and therefore both improving overall efficiency and reducing risk of excessive enamel removal.

Additional advantages of the invention will be set forth in part in the description which follows, and in part will be obvious from the description, or may be learned by practice of the invention. The advantages of the invention may be realized and attained by means of the instrumentalities and combinations particularly pointed out in the appended claims. Further benefits and advantages of the embodiments of the invention will become apparent from consideration of the following detailed description given with reference to the accompanying drawings, which specify and show (preferred embodiments of the present invention.

### BRIEF DESCRIPTION OF THE DRAWINGS

The accompanying drawings, which are incorporated into and constitute a part of this specification, illustrate one or more embodiments of the present invention and, together with the detailed description, serve to explain the principles and implementations of the invention.

FIG. 1 shows a perspective view of a first embodiment.

FIG. 2 shows bottom edge view of a first embodiment.

FIG. 3 shows a top edge view of a first embodiment.

FIG. 4 shows back view of a first embodiment.

FIG. 5 shows side view of a first embodiment.

FIG. 6 shows side view of a first embodiment.

FIG. 7 shows an exploded perspective view of a second embodiment.

FIG. 8 shows bottom edge view of a second embodiment.

FIG. 9 shows a top edge view of a second embodiment.

FIG. 10 shows back view of a second embodiment.

FIG. 11 shows side view of a second embodiment.

FIG. 12 shows side view of a second embodiment.

FIG. 13 shows a perspective view of a third embodiment.

FIG. 14 shows bottom edge view of a third embodiment.

FIG. 15 shows a top edge view of a third embodiment.

FIG. 16 shows back view of a third embodiment.

FIG. 17 shows side view of a third embodiment.

FIG. 18 shows side view of a third embodiment.

FIG. 19A shows a side view of a fourth embodiment.

FIG. 19B shows a side view of a fifth embodiment.

FIG. 20A shows a side view of a sixth embodiment.

FIG. 20B shows a side view of a seventh embodiment.

FIG. 21A shows a side view of a eighth embodiment.

FIG. 21B shows a side view of a ninth embodiment.

FIG. 22A shows a side view of a tenth embodiment.

FIG. 22B shows a side view of a eleventh embodiment.

### REFERENCE NUMBERS USED IN DRAWINGS

Turning now descriptively to the drawings, in which similar reference characters denote similar elements throughout the several views, the figures illustrate the present invention. With regard to the reference numerals used, the following numbering is used throughout the various drawing figures:
10 First Embodiment
12 Handle
14 Filing Strip
16 Horizontal Bridge
18 First Vertical Arm
20 Second Vertical Arm
22 First Horizontal Bridge End
24 Second Horizontal Bridge End
26 First Vertical Arm Terminal End
28 Second Vertical Arm Terminal End
30 First Vertical Arm Outer Surface
32 Second Vertical Arm Outer Surface
34 First Vertical Arm—Horizontal Bridge Connection Region
36 Second Vertical Arm—Horizontal Bridge Connection Region
38 Handle Front Surface
40 Handle Back Surface
42 Handle Corner/Connection Region of First Vertical Arm
44 Handle Corner/Connection Region of Second Vertical Arm
46 Bridge Outer Surface
100 First Set of Grip Portions
102 Second Set of Grip Portions
104 First Grip Portion on First Vertical Arm
106 Interstitial Grip Portion on First Vertical Arm
108 Interstitial Grip Portion on First Vertical Arm
110 Second Grip Portion on First Vertical Arm
112 First Grip Portion on Second Vertical Arm
114 Interstitial Grip Portion on Second Vertical Arm
116 Interstitial Grip Portion on Second Vertical Arm
118 Second Grip Portion on Second Vertical Arm
120 Outer surface of First Grip Portion on First Vertical Arm
122 Outer surface of Interstitial Grip Portion on First Vertical Arm
124 Outer surface of Interstitial Grip Portion on First Vertical Arm
126 Outer surface of Second Grip Portion on First Vertical Arm
128 Outer surface of First Grip Portion on Second Vertical Arm
130 Outer surface of Interstitial Grip Portion on Second Vertical Arm
132 Outer surface of Interstitial Grip Portion on Second Vertical Arm
134 Outer surface of Second Grip Portion on Second Vertical Arm
136 First Convex Grip Profile
138 Second Convex Grip Profile
140 First End Surface of First Grip Portion on First Vertical Arm
142 First End Surface of Interstitial Grip Portion on First Vertical Arm
144 First End Surface of Interstitial Grip Portion on First Vertical Arm
146 First End Surface of Second Grip Portion on First Vertical Arm
148 First End Surface of First Grip Portion on Second Vertical Arm
150 First End Surface of Interstitial Grip Portion on Second Vertical Arm
152 First End Surface of Interstitial Grip Portion on Second Vertical Arm
154 First End Surface of Second Grip Portion on Second Vertical Arm
156 Second End Surface of First Grip Portion on First Vertical Arm
158 Second End Surface of Interstitial Grip Portion on First Vertical Arm
160 Second End Surface of Interstitial Grip Portion on First Vertical Arm
162 Second End Surface of Second Grip Portion on First Vertical Arm
164 Second End Surface of First Grip Portion on Second Vertical Arm
166 Second End Surface of Interstitial Grip Portion on Second Vertical Arm
168 Second End Surface of Interstitial Grip Portion on Second Vertical Arm
170 Second End Surface of Second Grip Portion on Second Vertical Arm
172 First Vertical Arm Front Concave Grip Profile
174 Second Vertical Arm Front Concave Grip Profile
176 First Vertical Arm Back Concave Grip Profile
178 Second Vertical Arm Back Concave Grip Profile
1010 Second Embodiment
1012 Handle
1014 Filing Strip
1016 Horizontal Bridge
1018 First Vertical Arm
1020 Second Vertical Arm
1022 First Horizontal Bridge End
1024 Second Horizontal Bridge End
1026 First Vertical Arm Terminal End
1028 Second Vertical Arm Terminal End
1030 First Vertical Arm Outer Surface
1032 Second Vertical Arm Outer Surface
1034 First Vertical Arm—Horizontal Bridge Connection Region
1036 Second Vertical Arm—Horizontal Bridge Connection Region
1038 Handle Front Surface
1040 Handle Back Surface
1042 Handle Corner/Connection Region of First Vertical Arm
1044 Handle Corner/Connection Region of Second Vertical Arm
1046 Bridge Outer Surface
1048 Receiving Socket
1050 Coupler
1052 Dental Driver
1100 First Set of Grip Portions
1102 Second Set of Grip Portions
1104 First Grip Portion on First Vertical Arm
1106 Interstitial Grip Portion on First Vertical Arm
1108 Interstitial Grip Portion on First Vertical Arm
1110 Second Grip Portion on First Vertical Arm
1112 First Grip Portion on Second Vertical Arm
1114 Interstitial Grip Portion on Second Vertical Arm
1116 Interstitial Grip Portion on Second Vertical Arm
1118 Second Grip Portion on Second Vertical Arm
1120 Outer surface of First Grip Portion on First Vertical Arm
1122 Outer surface of Interstitial Grip Portion on First Vertical Arm
1124 Outer surface of Interstitial Grip Portion on First Vertical Arm
1126 Outer surface of Second Grip Portion on First Vertical Arm
1128 Outer surface of First Grip Portion on Second Vertical Arm
1130 Outer surface of Interstitial Grip Portion on Second Vertical Arm
1132 Outer surface of Interstitial Grip Portion on Second Vertical Arm
1134 Outer surface of Second Grip Portion on Second Vertical Arm
1136 First Convex Grip Profile
1138 Second Convex Grip Profile
1140 First End Surface of First Grip Portion on First Vertical Arm
1142 First End Surface of Interstitial Grip Portion on First Vertical Arm
1144 First End Surface of Interstitial Grip Portion on First Vertical Arm
1146 First End Surface of Second Grip Portion on First Vertical Arm
1148 First End Surface of First Grip Portion on Second Vertical Arm
1150 First End Surface of Interstitial Grip Portion on Second Vertical Arm
1152 First End Surface of Interstitial Grip Portion on Second Vertical Arm
1154 First End Surface of Second Grip Portion on Second Vertical Arm
1156 Second End Surface of First Grip Portion on First Vertical Arm
1158 Second End Surface of Interstitial Grip Portion on First Vertical Arm
1160 Second End Surface of Interstitial Grip Portion on First Vertical Arm
1162 Second End Surface of Second Grip Portion on First Vertical Arm
1164 Second End Surface of First Grip Portion on Second Vertical Arm
1166 Second End Surface of Interstitial Grip Portion on Second Vertical Arm
1168 Second End Surface of Interstitial Grip Portion on Second Vertical Arm
1170 Second End Surface of Second Grip Portion on Second Vertical Arm
1172 First Vertical Arm Front Concave Grip Profile
1174 Second Vertical Arm Front Concave Grip Profile
1176 First Vertical Arm Back Concave Grip Profile
1178 Second Vertical Arm Back Concave Grip Profile
2010 Third Embodiment
2012 Handle
2014 Filing Strip
2016 Horizontal Bridge
2018 First Vertical Arm
2020 Second Vertical Arm
2022 First Horizontal Bridge End
2024 Second Horizontal Bridge End
2026 First Vertical Arm Terminal End
2028 Second Vertical Arm Terminal End
2030 First Vertical Arm Outer Surface
2032 Second Vertical Arm Outer Surface
2034 First Vertical Arm—Horizontal Bridge Connection Region
2036 Second Vertical Arm—Horizontal Bridge Connection Region.
2038 Handle Front Surface
2040 Handle Back Surface
2042 Handle Corner/Connection Region of First Vertical Arm
2044 Handle Corner/Connection Region of Second Vertical Arm
2046 Bridge Outer Surface
2048 Projecting Coupler
2050 Dental Driver Tool Coupler
2052 Dental Driver
2100 First Set of Grip Portions
2102 Second Set of Grip Portions
2104 First Grip Portion on First Vertical Arm.
2106 Interstitial Grip Portion on First Vertical Arm
2108 Interstitial Grip Portion on First Vertical Arm
2110 Second Grip Portion on First Vertical Arm.
2112 First Grip Portion on Second Vertical Arm
2114 Interstitial Grip Portion on Second Vertical Arm
2116 Interstitial Grip Portion on Second Vertical Arm
2118 Second Grip Portion on Second Vertical Arm.
2120 Outer surface of First Grip Portion on First Vertical Arm
2122 Outer surface of Interstitial Grip Portion on First Vertical Arm
2124 Outer surface of Interstitial Grip Portion on First Vertical Arm
2126 Outer surface of Second Grip Portion on First Vertical Arm
2128 Outer surface of First Grip Portion on Second Vertical Arm
2130 Outer surface of Interstitial Grip Portion on Second Vertical Arm
2132 Outer surface of Interstitial Grip Portion on Second Vertical Arm
2134 Outer surface of Second Grip Portion on Second Vertical Arm
2136 First Concave Grip Profile
2138 Second Concave Grip Profile
2140 First End Surface of First Grip Portion on First Vertical Arm
2142 First End Surface of Interstitial Grip Portion on First Vertical Arm
2144 First End Surface of Interstitial Grip Portion on First Vertical Arm
2146 First End Surface of Second Grip Portion on First Vertical Arm
2148 First End Surface of First Grip Portion on Second Vertical Arm
2150 First End Surface of Interstitial Grip Portion on Second Vertical Arm
2152 First End Surface of Interstitial Grip Portion on Second Vertical Arm
2154 First End Surface of Second Grip Portion on Second Vertical Arm
2156 Second End Surface of First Grip Portion on First Vertical Arm
2158 Second End Surface of Interstitial Grip Portion on First Vertical Arm
2160 Second End Surface of Interstitial Grip Portion on First Vertical Arm
2162 Second End Surface of Second Grip Portion on First Vertical Arm
2164 Second End Surface of First Grip Portion on Second Vertical Arm
2166 Second End Surface of Interstitial Grip Portion on Second Vertical Arm
2168 Second End Surface of Interstitial Grip Portion on Second Vertical Arm
2170 Second End Surface of Second Grip Portion on Second Vertical Arm
2172 First Vertical Arm Front Concave Grip Profile
2174 Second Vertical Arm Front Concave Grip Profile
2176 First Vertical Arm Back Concave Grip Profile
2178 Second Vertical Arm Back Concave Grip Profile
2180 Projecting Coupler First Part
2182 Projecting Coupler Second Part
2184 Hollow Tube Coupling
2186 Tube Coupling First End
2188 Tube Coupling Second End
2190 Tube Coupling Open Seam
2192 Projecting Coupler/Filing Strip Overlap

### DETAILED DESCRIPTION

Before beginning a detailed description of the subject invention, mention of the following is in order. When appropriate, like reference materials and characters are used to designate identical, corresponding, or similar components in differing figure drawings. The figure drawings associated with this disclosure typically are not drawn with dimensional accuracy to scale, i.e., such drawings have been drafted with a focus on clarity of viewing and understanding rather than dimensional accuracy.

In the interest of clarity, not all of the routine features of the implementations described herein are shown and described. It will, of course, be appreciated that in the development of any such actual implementation, numerous implementation-specific decisions must be made in order to achieve the developer's specific goals, such as compliance with application- and business-related constraints, and that these specific goals will vary from one implementation to another and from one developer to another. Moreover, it will be appreciated that such a development effort might be complex and time-consuming, but would nevertheless be a routine undertaking of engineering for those of ordinary skill in the art having the benefit of this disclosure.

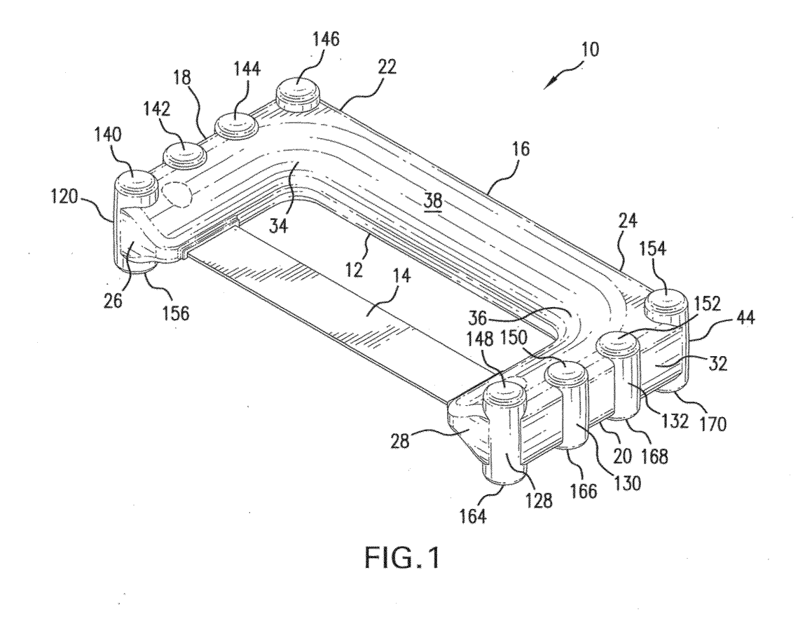

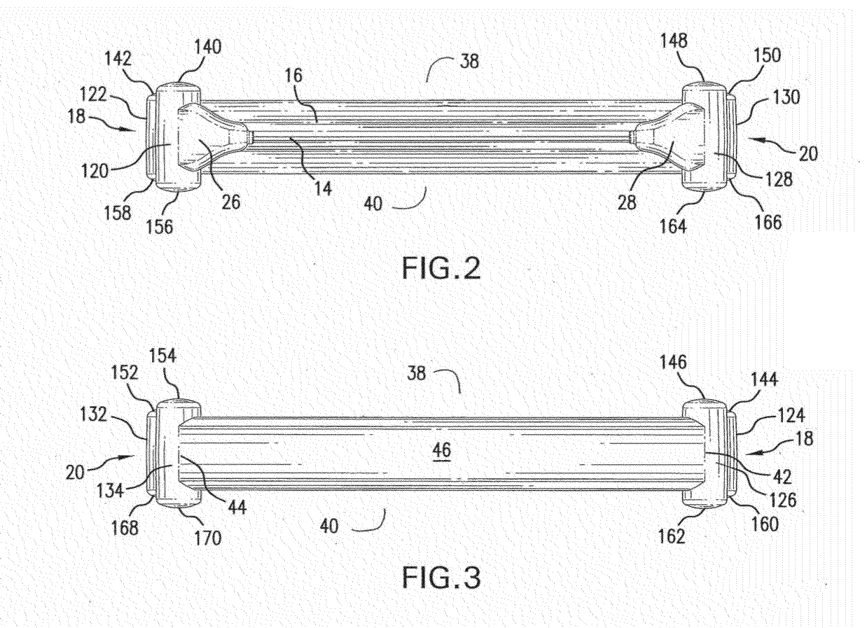

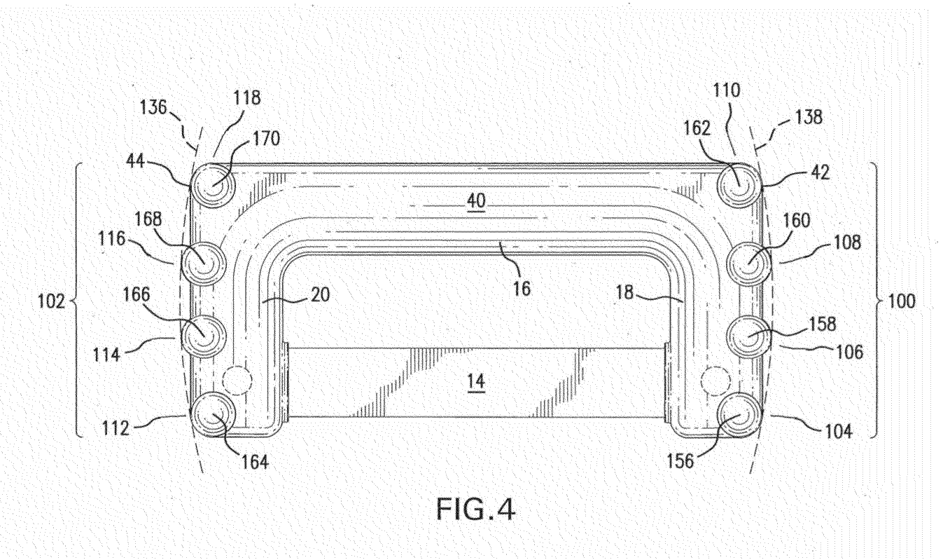

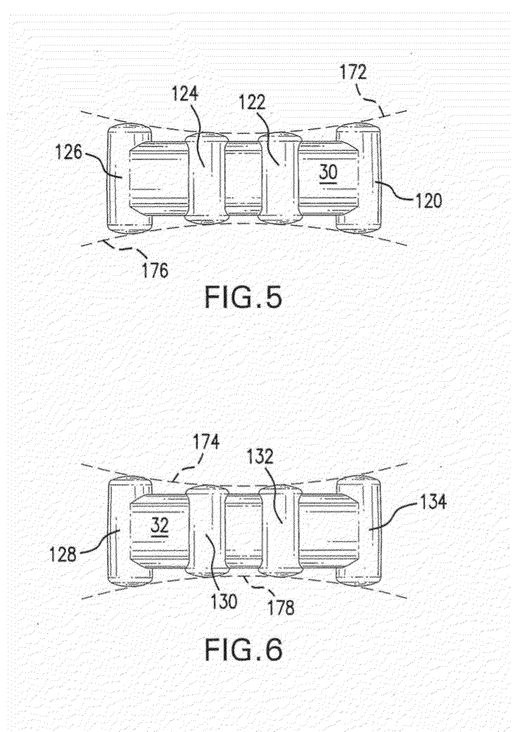

Referring to FIGS. 1-6, a first embodiment of an improved dental filing tool 10 is provided. FIGS. 1-6 generally demonstrate a pre-existing design. Referring to FIGS. 1-6, the pre-existing apparatus includes arcuate handle 12 and a filing strip 14. Handle 12 includes a horizontal bridge 16 and opposed first and second vertical arms 18, 20 extending in parallel from opposite ends 22, 24 of the bridge to terminal ends 26, 28, the vertical arms 18, 20 having outer surfaces 30, 32, respectively, and being adapted to hold filing strip 14 extending between them, the horizontal bridge 16 and vertical arms 18, 20 generally defining a handle plane.

The improvement includes first and second sets 100, 102 of partial-cylindrical grip portions 104, 106, 108, 110 and 112, 114, 116, 118, respectively, distributed along the outer surfaces 30, 32 of the first and second vertical arms 18, 20, respectively, the grip portions 104-118 extending longitudinally from a first end surface, 140-154, respectively, proximate to—and extending past—the handle front surface to a second end surface 156-170, respectively, proximate to—and extending past—the handle back surface. The partial-cylindrical grip portions 104-118 are aligned normal (i.e. with the longitudinal axis aligned transversely) to the handle plane. Grip portions 104-118 are described as “partial-cylindrical” because the general shape of the protruding portion of their profiles appears like a cylinder embedded transversely within the respective handle vertical arms 18 and 20. Rounded cross-sections such as circles or ovals may provide greater comfort, but a user may prefer sharper edges for use with thicker latex gloves. Rounded cross-sections also make it easier to apply a rounded end surface (140-170) if desired, because the three-dimensional shape is less complex. Additionally, rounded shapes may be easier to produce by injection molding methods, with less dimensional instability problems (common at corner profiles) and more uniform melting.

Each set 100, 102 includes a first grip portion 102, 112 disposed proximate the respective vertical arm terminal end 26, 28, a second grip portion 110, 118 disposed proximate the connection region 34, 36 of the bridge 16 and respective vertical arm 18, 20, and a plurality of spaced-apart interstitial grip portions 106, 108 and 114, 116 distributed between the first and second grip portions 104, 110 and 112, 118, respectively.

The outer surfaces 120, 122, 124, 126 and 128, 130, 132, 134 of each of the first and second sets 100, 102, respectively, trace a convex grip profile, 136, 138, respectively. Outer surfaces 120-134 refer to the exposed exterior surfaces proximate the first and second arm outer surfaces 30, 32, and excluding end surfaces 140-170. Convex grip profiles 136, 138, can be described as tangent arcs, as each represents a continuous arc intersecting a point on the perimeter or outer surface 120-134 of each grip portion 104-118.

Each grip portion 104-118 extends from a first end surface 140, 142, 144, 146, 148 150, 152, 154, respectively, to a second end surface 156, 158, 160, 162, 164, 166, 168, 170, respectively. The respective end surfaces 140-154 project outward from the respective front and back handle surfaces, 38 and 40, to provide enhanced grip when held front-back (in the embodiment, the handle front and back form mirror images). In the embodiment, the end surfaces of each of first and second sets 100, 102 of grip portions 104-118, project outward from the handle front and back surfaces 38, 40, and trace a concave grip profile 172, 174, 176, 178, with each of the first and second grip portions 104, 112 and 110,116, respectively, projecting farther than the respective interstitial grip portions 106, 108 and 114, 116. In the embodiment, the concave grip profiles 172478 trace a tangent arc which intersects with the end-point of each end surface 140-146, 148-154, 156-162 and 164-170, respectively.

In the embodiment, each of the grip portion first and second end surfaces 140-170 are rounded, in this case semispherical. Other end surface profiles could be used as well. The rounded surfaces provide greater comfort when tightly gripped.

In the embodiment, each first grip portion 104, 112 is located at the vertical arm terminal end 24, 26, respectively. Each first grip portion 104, 112 radius matches the corner radius of its respective vertical arm terminal end, 24, 26 such that each outer surface 120, 128 of the respective first grip portion 104, 112 is flush with the outer surface of the vertical arm terminal end 26, 28, respectively.

In the embodiment, each of the second grip portions, 110 and 118, respectively, is located at the corner of the handle 12, at the connection region 42, 44 of the respective vertical arm 18, 20 and horizontal bridge first and second ends 22, 24. Each second grip portion radius matches the corner radius of handle 12, such that the outer surface 126, 134 of the respective second grip portion is flush with the outer surfaces of the respective vertical arm 30, 32 and horizontal bridge outer surface 46.

Providing grip portions at the “four corners” of a filing tool, with outer surfaces matching the outer surface contours of the filing tool handle, provides improved grip when fingers are positioned across the diagonal, and provide easier shifting of the user's grip between points along the entire span of the vertical arms—an important consideration in the confined space of a patient's mouth. The convex end-to-end grip profiles 136, 138 and the concave front-to-back grip profiles 172, 174, 176, 178 provide enhanced gripping for any orientation of the gripping fingers.

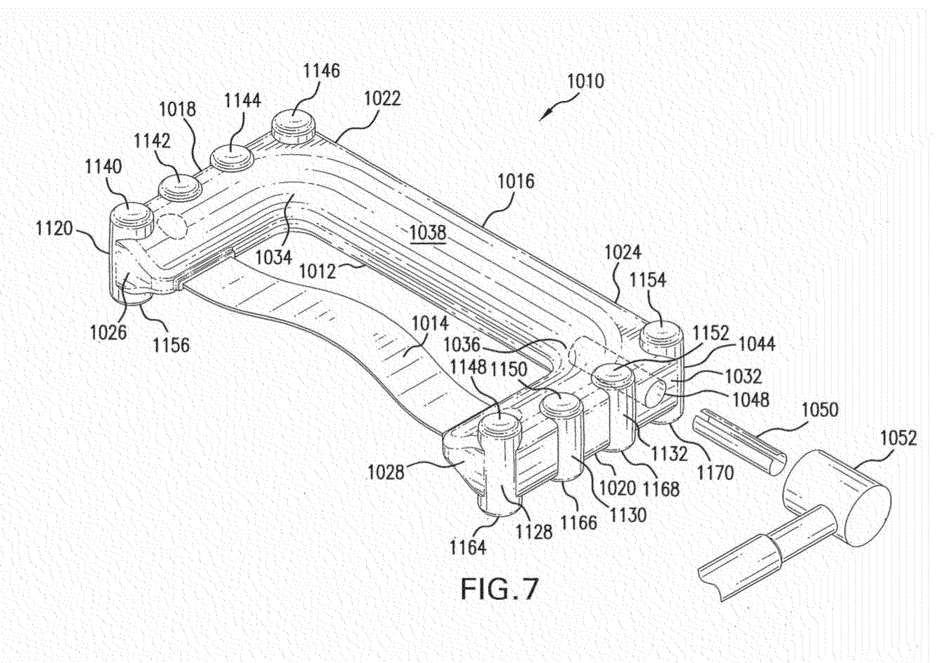

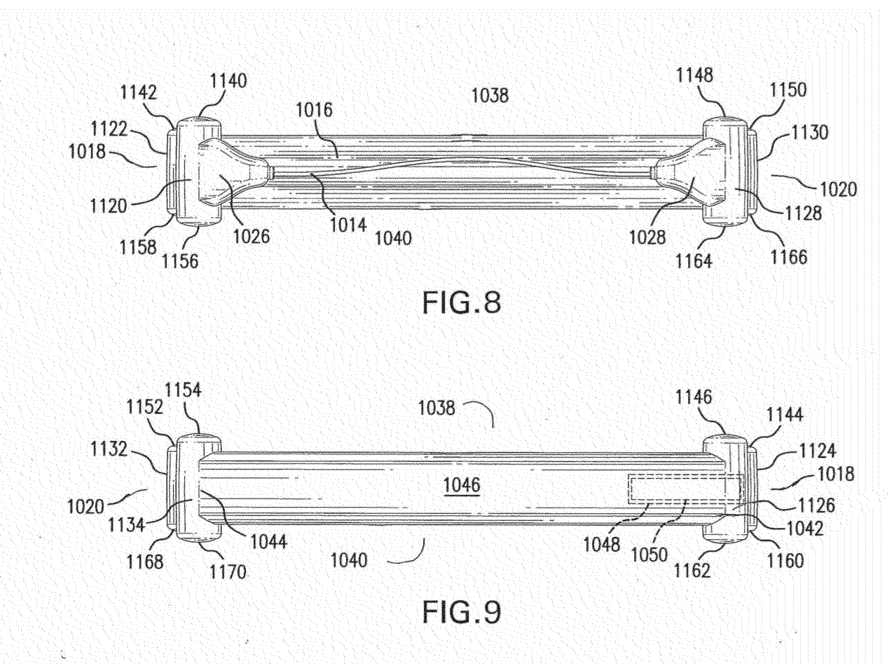

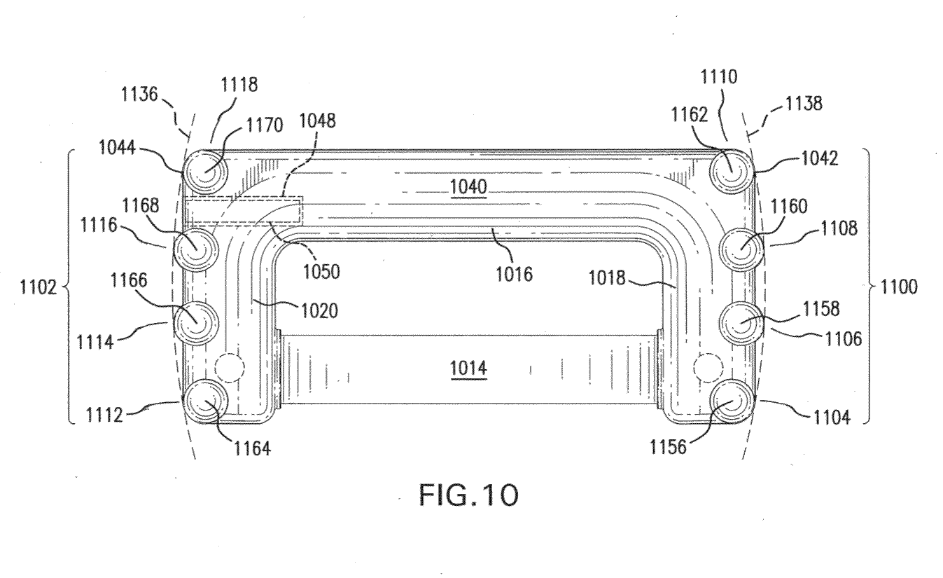

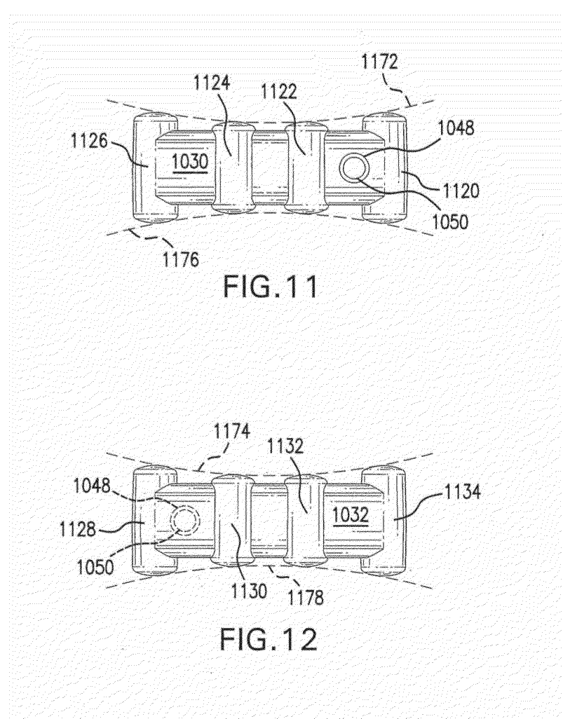

Referring to FIGS. 7-12, a second embodiment 1010 is shown demonstrating an improved filing tool couplable to a power-driven dental driver. FIGS. 7-12 generally demonstrate a pre-existing design as in the first embodiment, but the improvement further including a receiving socket 1048 embedded within handle 1012, proximate the second vertical arm—horizontal bridge connection region 1036 and extending into horizontal bridge 1016. Receiving socket 1048 is adapted to receive a coupler 1050, the coupler 1050 to removably couple the apparatus 1010 to a dental driver tool. The pre-existing apparatus includes arcuate handle 1012 and a filing strip 1014. Handle 1012 includes a horizontal bridge 1016 and opposed first and second vertical arms 1018, 1020 extending in parallel from opposite ends 1022, 1024 of the bridge to terminal ends 1026, 1028, the vertical arms 1018, 1020 having outer surfaces 1030, 1032, respectively, and being adapted to hold filing strip 1014 extending between them, the horizontal bridge 1016 and vertical arms 1018, 1020 generally defining a handle plane. Receiving socket 1048 is inset within handle 1012, and adapted to receive a coupler 1050 to removably couple to a dental driver 1052. Receiving socket 1048 does not extend beyond outer surfaces 11204134 so as not to interfere with manual gripping. In the embodiment, the edge of receiving socket 1048 is flush with first arm outer surface 1032.

The improvement includes first and second sets 1100, 1102 of partial-cylindrical grip portions 1104, 1106, 1108, 1110 and 1112, 1114, 1116, 1118, respectively, distributed along the outer surfaces 1030, 1032 of the first and second vertical arms 1018, 1020, respectively, the grip portions 11044118 extending longitudinally from a first end surface, 1140-454, respectively, proximate to—and extending past—the handle front surface to a second end surface 1156-1170, respectively, proximate to—and extending past—the handle back surface. The partial-cylindrical grip portions 1104-1118 are aligned normal (i.e. with the longitudinal axis aligned transversely) to the handle plane. Grip portions 1104-1118 are described as “partial-cylindrical” because the general shape of the protruding portion of their profiles appears like a cylinder embedded transversely within the respective handle vertical arms 1018 and 1020. Rounded cross-sections such as circles or ovals may provide greater comfort, but a user may prefer sharper edges for use with thicker latex gloves. Rounded cross-sections also make it easier to apply a rounded end surface (1140-1170) if desired, because the three-dimensional shape is less complex. Additionally, rounded shapes may be easier to produce by injection molding methods, with less dimensional instability problems (common at corner profiles) and more uniform melting.

Each set 1100, 1102 includes a first grip portion 1102, 1112 disposed proximate the respective vertical arm terminal end 1026, 1028, a second grip portion 1110, 1118 disposed proximate the connection region 1034, 1036 of the bridge 1016 and respective vertical arm 1018, 1020, and a plurality of spaced-apart interstitial grip portions 1106, 1108 and 1114, 1116 distributed between the first and second grip portions 1104, 1110 and 1112, 1118, respectively.

The outer surfaces 1120, 1122, 1124, 1126 and 1128, 1130, 1132, 1134 of each of the first and second sets 1100, 1102, respectively, trace a convex grip profile, 1136, 1138, respectively. Outer surfaces 1120-1134 refer to the exposed exterior surfaces proximate the first and second arm outer surfaces 1030, 1032, and excluding end surfaces 1140-1170. Convex grip profiles 1136, 1138, can be described as tangent arcs, as each represents a continuous arc intersecting a point on the perimeter our outer surface 1120-1134 of each grip portion 1104-1118.

Each grip portion 1104-1118 extends from a first end surface 1140, 1142, 1144, 1146, 1148 1150, 1152, 1154, respectively, to a second end surface 1156, 1158, 1160, 1162, 1164, 1166, 1168, 1170, respectively. The respective end surfaces 1140-1154 project outward from the respective front and back handle surfaces, 1038 and 1140, to provide enhanced grip when held front-back (in the embodiment, the handle front and back form mirror images). In the embodiment, the end surfaces of each of first and second sets 1100, 1102 of grip portions 1104-1118, project outward from the handle front and back surfaces 1038, 1040, and trace a concave grip profile 1172, 1174, 1176, 1178, with each of the first and second grip portions 1104, 1112 and 1110, 1116, respectively, projecting farther than the respective interstitial grip portions 1106, 1108 and 1114, 1116. In the embodiment, the concave grip profiles 1172-1178 trace a tangent arc which intersects with the end-point of each end surface 1140-1146, 1148-1154, 1156-1162 and 1164-1170, respectively.

In the embodiment, each of the grip portion first and second end surfaces 1140-1170 are rounded, in this case semispherical. Other end surface profiles could be used as well. The rounded surfaces provide greater comfort when tightly gripped.

In the embodiment, each first grip portion 1104, 1112 is located at the vertical arm terminal end 1024, 1026, respectively. Each first grip portion 1104, 1112 radius matches the corner radius of its respective vertical arm terminal end, 1024, 1026 such that each outer surface 1120, 1128 of the respective first grip portion 1104, 1112 is flush with the outer surface of the vertical arm terminal end 1026, 1028, respectively.

In the embodiment, each of the second grip portions, 1110 and 1118, respectively, is located at the corner of the handle 1012, at the connection region 1042, 1044 of the respective vertical arm 1018, 1020 and horizontal bridge first and second ends 1022, 1024. Each second grip portion radius matches the corner radius of handle 1012, such that the outer surface 1126, 1134 of the respective second grip portion is flush with the outer surfaces of the respective vertical arm 1030, 1032 and horizontal bridge outer surface 1046.

The operation of the embodiments is straight forward. The user grips the filing tool handle 12, 1012 with two fingers—typically a thumb and forefinger—at the desired orientation to reach the location to be worked on within a patient's mouth, shifting the orientation of the grip as desired. Any number of methods may be used to produce the improved handle, the most common being by injection molding plastic. However, the handle grip may be accomplished by laser cutting methods, stamping and die cutting, or any other suitable method depending on the handle material.

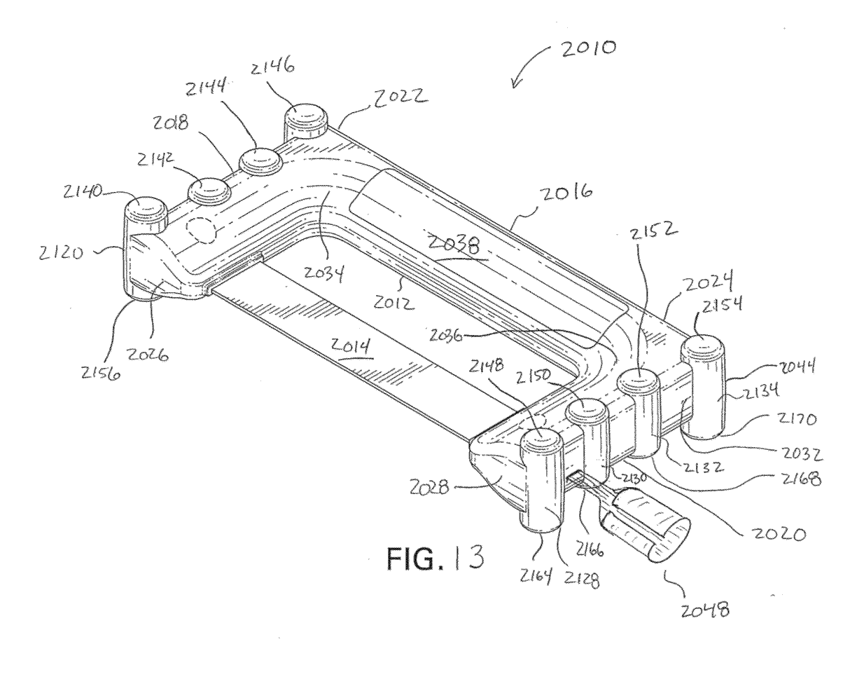

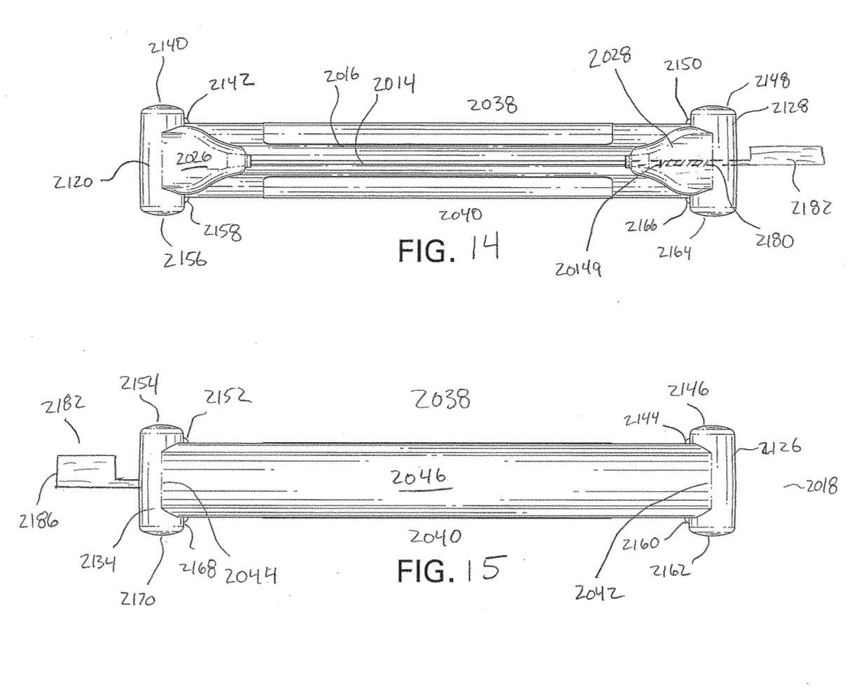

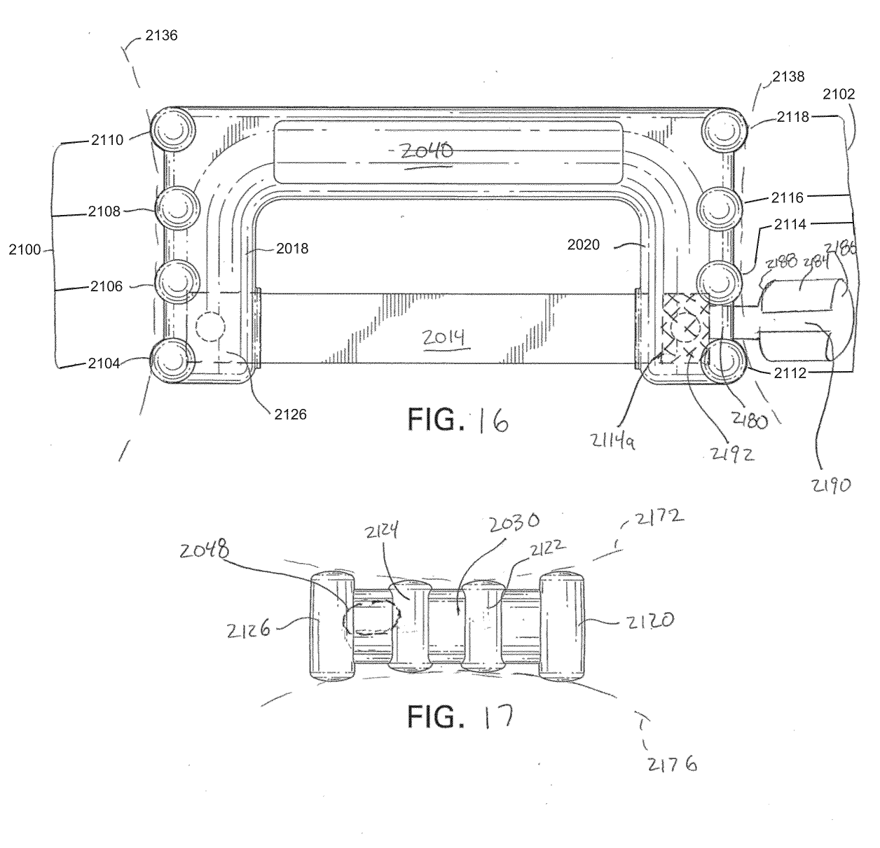

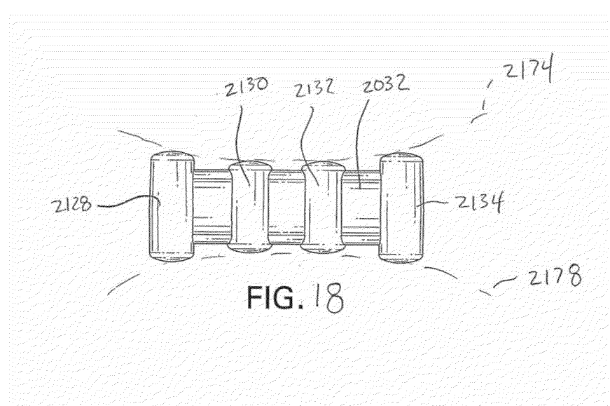

Referring to FIGS. 13-18, a third embodiment 2010 is shown demonstrating an improved filing tool couplable to a power-driven dental driver. FIGS. 13-18 generally demonstrate a pre-existing design as in the first and second embodiments, but the improvement further includes a projecting coupler 2048 projecting from handle 2012, proximate the second vertical arm terminal end 2028.

The pre-existing apparatus includes arcuate handle 2012 and a filing strip 2014. Handle 2012 includes a horizontal bridge 2016 and opposed first and second vertical arms 2018, 2020 extending in parallel from opposite ends 2022, 2024 of the bridge to terminal ends 2026, 2028, the vertical arms 2018, 2020 having outer surfaces 2030, 2032, respectively, and being adapted to hold filing strip 2014 extending between them, the horizontal bridge 2016 and vertical arms 2018, 2020 generally defining a handle plane.

The improvement includes first and second sets 2100, 2102 of partial-cylindrical grip portions 2104, 2106, 2108, 2110 and 2112, 2114, 2116, 2118, respectively, distributed along the outer surfaces 2030, 2032 of the first and second vertical arms 2018, 2020, respectively, the grip portions 2104-2118 extending longitudinally from a first end surface, 2140-2154, respectively, proximate to—and extending past—the handle front surface to a second end surface 2156-2170, respectively, proximate to—and extending past—the handle back surface. The partial-cylindrical grip portions 2104-2118 are aligned normal (i.e. with the longitudinal axis aligned transversely) to the handle plane. Grip portions 2104-2118 are described as “partial-cylindrical” because the general shape of the protruding portion of their profiles appears like a cylinder embedded transversely within the respective handle vertical arms 2018 and 2020. Rounded cross-sections such as circles or ovals may provide greater comfort, but a user may prefer sharper edges for use with thicker latex gloves. Rounded cross-sections also make it easier to apply a rounded end surface (2140-2170) if desired, because the three-dimensional shape is less complex. Additionally, rounded shapes may be easier to produce by injection molding methods, with less dimensional instability problems (common at corner profiles) and more uniform melting.

Each set 2100, 2102 includes a first grip portion 2102, 2112 disposed proximate the respective vertical arm terminal end 2026, 2028, a second grip portion 2110, 2118 disposed proximate the connection region 2034, 2036 of the bridge 2016 and respective vertical arm 2018, 2020, and a plurality of spaced-apart interstitial grip portions 2106, 2108 and 2114, 2116 distributed between the first and second grip portions 2104, 2110 and 2112, 2118, respectively.

In the embodiment, the outer surfaces 2120, 2122, 2124, 2126 and 2128, 2130, 2132, 2134 of each of the first and second sets 2100, 2102, respectively, trace a concave grip profile, 2136, 2138, respectively. Outer surfaces 2120-2134 refer to the exposed exterior surfaces proximate the first and second arm outer surfaces 2030, 2032, and excluding end surfaces 2140-2170. Convex grip profiles 2136, 2138, can be described as tangent arcs, as each represents a continuous arc intersecting a point on the perimeter our outer surface 2120-2134 of each grip portion 2104-2118.

Each grip portion 2104-2118 extends from a first end surface 2140, 2142, 2144, 2146, 2148, 2150, 2152, 2154, respectively, to a second end surface 2156, 2158, 2160, 2162, 2164, 2166, 2168, 2170, respectively. The respective end surfaces 2140-2154 project outward from the respective front and back handle surfaces, 2038 and 2040, to provide enhanced grip when held front-back (in the embodiment, the handle front and back form mirror images). In the embodiment, the end surfaces of each of first and second sets 2100, 2102 of grip portions 2104-2118, project outward from the handle front and back surfaces 2038, 2040, and trace a concave grip profile 2172, 2174, 2176, 2178, with each of the first and second grip portions 2104, 2112 and 2110, 2116, respectively, projecting farther than the respective interstitial grip portions 2106, 2108 and 2114, 2116. In the embodiment, the concave grip profiles 2172-2178 trace a tangent arc which intersects with the end-point of each end surface 2140-2146, 2148-2154, 2156-2162 and 2164-2170, respectively.

In the embodiment, each of the grip portion first and second end surfaces 2140-2170 are rounded, in this case semispherical. Other end surface profiles could be used as well. The rounded surfaces provide greater comfort when tightly gripped.

In the embodiment, each first grip portion1 2104, 2112 is located at the vertical arm terminal end 2024, 2026, respectively. In the embodiment, each of the second grip portions, 2110 and 2118, respectively, is located at the corner of the handle 2012, at the connection region 2042, 2044 of the respective vertical arm 2018, 2020 and horizontal bridge first and second ends 2022, 2024.

Projecting coupler 2048 includes a first part 2180 embedded within second vertical arm 2020 proximate second vertical arm terminal end 1028 and overlapping a terminal end of filing strip 2014, and a second part 2182 extending outward from second vertical arm 2020, the second part 2182 including a coupling 2184 to engage a dental driver. Projecting coupler first part 2180 may be embedded at another location within handle 2012 which provides sufficient depth of material to reliably hold and support projecting coupler 2048, for example proximate second vertical arm-horizontal bridge connection region 1036. Aligning projecting coupler 2048 with filing strip 2014 provides several additional advantages, such as: (1) projecting coupler 2048 interferes less with manual use of the improved file when gripped end-to-end; (2) the force applied by the dental driver is aligned with the resistance from the dental strip, thereby minimizing torque and fatigue on the coupler; and, (3) the filing strip 2014 and projecting coupler 2048 may be formed from a single piece of material, or joined to form a continuous body, to enhance the strength of the coupler and apparatus overall. In the described embodiment, hatched region 2192 shows the overlapping of the projecting coupler first end 2180 and an end of filing strip 2014a.

In the third embodiment, the coupler second part 2182 includes a hollow tube coupling 2184 extending from a first end 2186 connected to the projecting coupler first part 2180 to a second end 2188, the tube coupling open at the second end 2188, the tube further including an open seam 2190 extending from the tube second end 2188 to the tube first end 2186. Seam 2190 allows tube coupling 2184 to flex open slightly in order to tightly grip around a corresponding mounting post or stub, or compress slightly to fit tightly within a corresponding receiving sleeve. The thickness and dimensions of tube coupling 2184 are selected to remain within the elastic range of the material when engaged to a selected dental driver tool coupler, such that the spring tension causes tube coupling 2184 to tightly grip a mounting post of a selected dental driver tool.

The concave end-grip design of the third embodiment may be combined with the flush socket coupling design of the second embodiment, and the convex end-grip design of the first and second embodiments may be combined with the projecting coupler design of the third embodiment.

Partial-cylinder portions have additional advantages relating to handles with tapered interior edges. The partial-cylinder outer surfaces and end surfaces provide enhanced surface area for gripping an otherwise thin edge-region, with improved gripping ability over simply knurling the surface or a uniform protrusion pattern distributed over the entire surface.

The improved handle may be used with filing strips mounted under tension or bowed. Additionally, the improved handle is useful in conjunction with a manual filing tool couplable to a power driven dental driver. The partial-cylindrical grip portions extend outward past the coupler used to connect to the driver, providing greater comfort and more reliable manual grip.

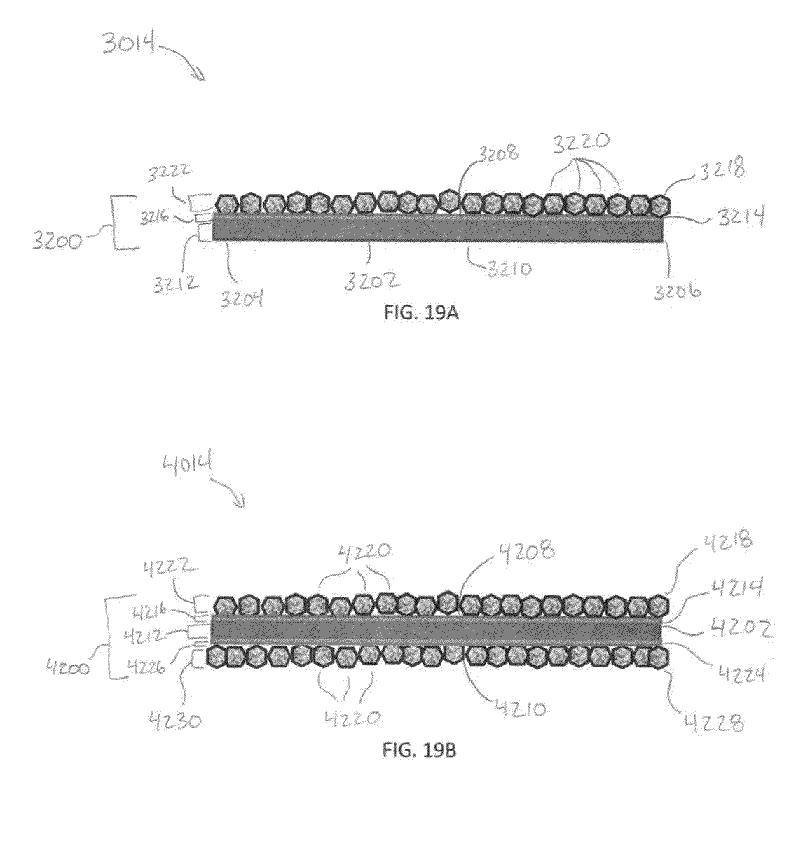

Referring to FIGS. 19A & B, a fourth embodiment is provided, including an improved dental filing strip system. In the embodiment, a system 3010 includes a first dental filing strip 3014, which may be coupled to an arcuate handle configured as in the first, second and third described embodiments 12, 1012 or 2012, above. In the embodiment, first dental filing strip 3014 has a selected total thickness 3200 of approximately 0.30 mm, or 300 um. Filing strip 3014 includes a flexible base metal strip 3202 extending lengthwise from a first end 3204 to a second end 3206, and extending widthwise from a first edge to a second edge, and including first and second surfaces 3208 and 3210, respectively, and having a base strip thickness 3212. A first adhering layer 3214 is applied to the strip first surface 3208 and has a first adhering layer thickness 3216. A first abrasive layer 3218 includes abrasive particles 3220 adhered to the strip first surface by the first adhering layer, the first abrasive layer 3218 having a first abrasive layer thickness 3222 determined by the nominal average cross-section of the abrasive particles 3220, wherein the first abrasive layer thickness 3222 is not greater than 35 um, corresponding to a nominal average particle size of 35 um. In practice, the inventor has found that an abrasive layer having nominal average particle size in the range 25 um to 35 um is optimum for providing adequate removal rates while not imparting undesirably deep scratching on the enamel surface or necessitating excessive additional polishing with a much finer particulate size.

In the embodiment, the first base metal strip base thickness 3212 is approximately 0.25 mm thick (250 um). First adhering layer 3214 comprises a layer of electroplated nickel into which a layer of diamond particles 3220 is embedded, the first adhering layer 3214 being approximately 0.01 mm thick (10 um). Additionally, provision is made for typical manufacturing deviation of the complete strip of approximately 0.01 mm (10 um). Therefore, the total thickness 3200 is 250 um (base metal strip)+10 um (first adhering layer)+35 um (first abrasive layer)=295 um. Accounting for potential manufacturing deviation of 10 um=305 um, or approximately 0.30 mm total thickness.

Referring to FIG. 19B, the improved dental filing strip system includes a second filing strip 4014 similar to the first dental filing strip 3014, but being double sided and selected to have a total thickness 4200 of 0.35 mm (350 um). The second filing strip base metal strip 4202 includes opposite first and second metal strip surfaces 4208, 4210, and corresponding first and second adhering layers 4214, 4224, electroplated onto the second base metal strip 4202 and having corresponding first and second adhering layer thicknesses, 4216, 4226. First and second abrasive layers 4218, 4228, include abrasive particles 4220 adhered to the second base metal strip first and second surfaces, 4208, 4210, respectively, by the first and second adhering layers, 4214, 4224, respectively. Each of the first and second abrasive layers 4218, 4228, has a corresponding abrasive layer thickness 4222, 4230, determined by the nominal average cross-section of the abrasive particles 4220. In the embodiment, the first and second abrasive layer thicknesses 4222, 4230, are each approximately 35 um. The second dental filing strip total thickness 4200 is therefore the sum of the second base metal strip 4212 (0.25 mm), the first and second adhering layers 4216 and 4226 (2×001 mm), the first and second abrasive layers 4222 and 4230 (2×0.035 mm), and the manufacturing tolerance (0.01 mm), or 0.35 mm (350 um) total.

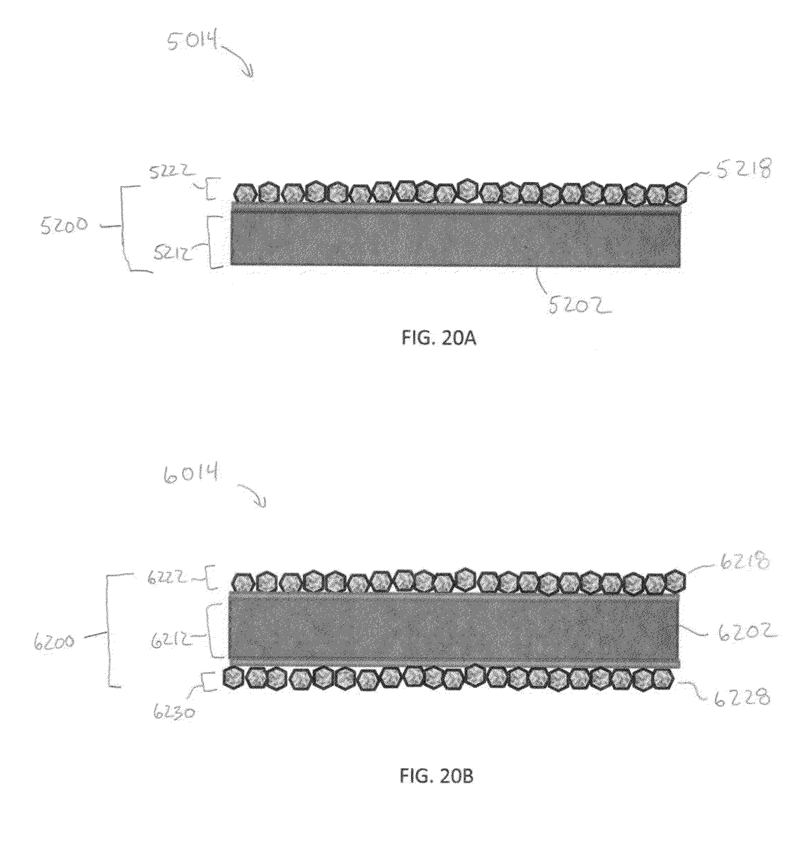

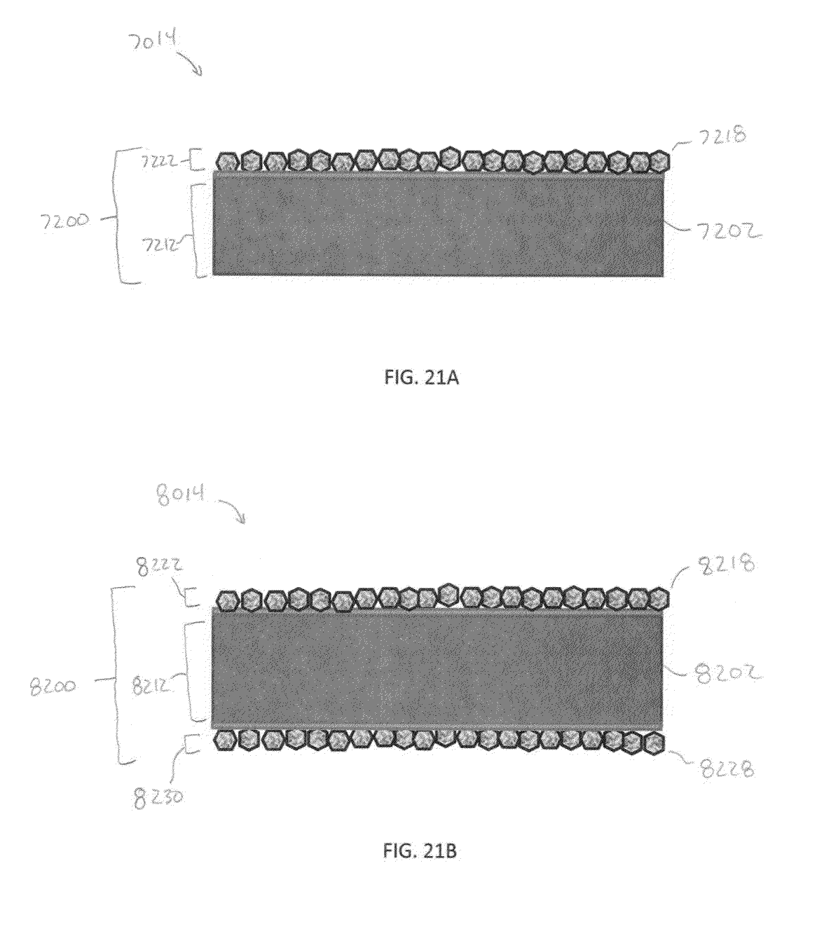

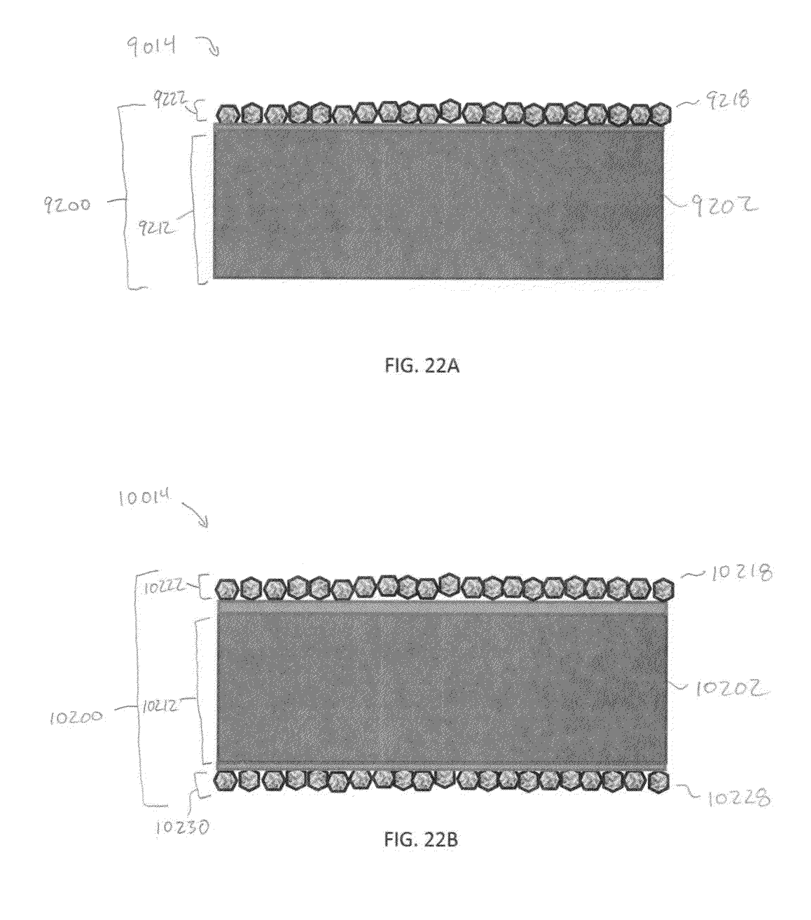

Referring to FIGS. 20A & B, FIGS. 214 & B, and FIGS. 22A & B, further embodiments 5014, 6014, 7014, 8014, 9014 and 10014 are shown, wherein the selected total thickness of each dental filing strip, 5200, 6200, 7200, 8200, 9200, 10200, respectively, is incrementally greater, but the nominal average particle size, which determines the abrasive layer thicknesses 5222, 6222, 6230, 7222, 8222, 8230, 9222, 10222, 10230, respectively, are maintained constant, at approximately 0.035 mm (35 um). The incremental increases in total thickness are achieved by providing incrementally thicker base metal strips 5202, 6202, 7202, 8202, 9202, 10202, respectively, to which the fine-particle abrasive layers 5218, 6218, 62228, 7218, 8218, 8228, 9218, 10218, 10228, respectively, are adhered. Therefore, FIG. 20A, illustrating a single-surface filing strip 5014 of approximately 0.35 m (350 um) total thickness 5200, includes a base metal strip 5202 having thickness 5212 of 0.30 mm (300 um). FIG. 20B, illustrating a double-sided filing strip 6014 of approximately 0.40 mm (400 um) total thickness 6200, includes a base metal strip 6202 having thickness 6212 of 0.30 mm (300 um). FIGS. 21A and 21B, illustrating a single-sided filing strip 7014 of approximately 0.40 mm (400 um) total thickness 7200 and a double-sided tiling strip 8014 of approximately 0.45 mm (450 um) total thickness 8200, respectively, each include a base metal strip 7202, 8202, respectively, having thicknesses 7212, 8212, respectively, of 0.35 mm (350 um). FIGS. 22A and 22B, illustrating a single-sided filing strip 9014 of approximately 0.45 mm (450 um) total thickness 9200 and a double-sided filing strip 10014 of approximately 0.50 mm (500 um) total thickness 10200, respectively, each include a base metal strip 9202, 10002, respectively, having thicknesses 9212, 10212, respectively, of 0.40 mm (400 um). In this way, the system provides the ability to select a single-sided or double-sided dental filing tool to match the desired interproximal clearance, but utilize a fine abrasive particle size which avoids undesirable scratching and/or excessive polishing and material removal.

The dental filing strips and system illustrated in the fourth through eleventh embodiments can be used coupled with improved handle designs disclosed herein, for example an arcuate handle configured as in the first, second and third described embodiments 12, 1012 or 2012, above, yielding significant advantages. The dental filing strips and system illustrated in the fourth-eleventh embodiments may also be used as manually held bare strips which, although lacking certain advantages of the described handle design, still provide the advantages of providing selected incremental total thicknesses to correspond with desired interproximal clearances, but avoiding the deep scratching and excessive polishing requirements caused by incrementally larger abrasive particle sizes.

Those skilled in the art will recognize that numerous modifications and changes may be made to the preferred embodiment without departing from the scope of the claimed invention. It will, of course, be understood that modifications of the invention, in its various aspects, will be apparent to those skilled in the art, some being apparent only after study, others being matters of routine mechanical, chemical and electronic design. No single feature, function or property of the preferred embodiment is essential. Other embodiments are possible, their specific designs depending upon the particular application. As such, the scope of the invention should not be limited by the particular embodiments herein described but should be defined only by the appended claims and equivalents thereof.

I claim:

1. An improved dental filing strip system, comprising a first dental filing strip having a selected total thickness, the first dental filing strip including:
a flexible base metal strip extending lengthwise from a first end to a second end, and extending widthwise from a first edge to a second edge, and including first and second surfaces, the strip having a base thickness;
a first adhering layer applied to the strip first surface, the first adhering layer having a first adhering layer thickness; and,
a first abrasive layer comprising abrasive particles adhered to the strip first surface by the first adhering layer, the first abrasive layer having a first abrasive layer thickness determined by the nominal average cross-section of the abrasive particles, wherein the first abrasive layer thickness is not greater than 35 um.

2. An improved dental filing strip system as in claim 1, further comprising:
wherein the first abrasive layer thickness is in the range 25-35 um.

3. An improved dental filing strip system as in claim 1, further comprising:
a second adhering layer applied to the strip second surface, the second adhering layer having a second adhering layer thickness; and,
a second abrasive layer comprising abrasive particles adhered to the strip second surface by the second adhering layer, the second abrasive layer having a second abrasive layer thickness determined by the nominal average cross-section of the abrasive particles, wherein the second abrasive layer thickness is not greater than 35 um.

4. An improved dental filing strip system as in claim 3, further comprising:
wherein the second abrasive layer thickness is in the range 25-35 um.

5. An improved dental filing strip system as in claim 1, further comprising a plurality of dental filing strips, each of the plurality of dental filing strips including:
a flexible base metal strip extending lengthwise from a first end to a second end, and extending widthwise from a first edge to a second edge, and including first and second surfaces, each strip having a respective base thickness;
a first adhering layer applied to each strip first surface, the respective first adhering layer having a respective first adhering layer thickness; and,
a first abrasive layer comprising abrasive particles adhered to each respective strip first surface by the respective first adhering layer, each respective first abrasive layer having a respective first abrasive layer thickness determined by the nominal average cross-section of the abrasive particles, wherein each respective first abrasive layer thickness is not greater than 35 um.

6. An improved dental filing strip system as in claim 5, further comprising at least one of the plurality of dental filing strips further including:
a second adhering layer applied to each of the respective strip second surfaces, each respective second adhering layer having a respective second adhering layer thickness; and,
a second abrasive layer comprising abrasive particles adhered to each respective strip second surface by the respective second adhering layer, each respective second abrasive layer having a respective second abrasive layer thickness determined by the nominal average cross-section of the abrasive particles, wherein each respective second abrasive layer thickness is not greater than 35 um.

7. An improved dental tiling strip system as in claim 5, further comprising wherein the plurality of dental filing strips includes strips having total thicknesses of approximately 0.30 mm, 0.35 mm, 0.40 mm, 0.45 mm and 0.50 mm, and the respective.

8. An improved dental filing strip system as in claim 7, further comprising wherein the plurality of dental tiling strips have base metal strip thicknesses of approximately 0.25 mm, 0.30 mm, 0.35 mm, 0.40 mm and 0.45 mm, respectively.

9. An improved dental filing strip system as in claim 6, further comprising wherein the plurality of dental filing strips includes strips having total thicknesses of approximately 0.35 mm, 0.40 mm, 0.45 mm and 0.50 mm, and the respective.

10. An improved dental filing strip system as in claim 7, further comprising wherein the plurality of dental filing strips have base metal strip thicknesses of approximately 0.25 mm, 0.30 mm, 0.35 mm and 0.40 mm, respectively.

11. An improved dental filing strip system as in claim 1, further comprising:
an arcuate handle having a horizontal bridge and opposed first and second vertical arms extending from opposite ends of the bridge to terminal ends,
wherein the dental filing strip first and second ends are coupled to the handle proximate the respective first and second vertical arm terminal ends.

12. An improved dental filing strip system as in claim 3, further comprising:
an arcuate handle having a horizontal bridge and opposed first and second vertical arms extending from opposite ends of the bridge to terminal ends;
wherein the dental filing strip first and second ends are coupled to the handle proximate the respective first and second vertical arm terminal ends.

13. An improved dental filing strip system as in claim 5, further comprising:
a plurality of arcuate handles corresponding to the plurality of dental filing strips, each of the plurality of handles having a horizontal bridge and opposed first and second vertical arms extending from opposite ends of the bridge to terminal ends;
wherein each of the respective dental filing strip first and second ends are coupled to the corresponding handle proximate the respective first and second vertical arm terminal ends.

14. An improved dental filing strip system as in claim 6, further comprising:
a plurality of arcuate handles corresponding to the plurality of dental filing strips, each of the plurality of handles having a horizontal bridge and opposed first and second vertical arms extending from opposite ends of the bridge to terminal ends;
wherein each of the respective dental tiling strip first and second ends are coupled to the corresponding handle proximate the respective first and second vertical arm terminal ends.

15. An improved dental filing strip system as in claim 11, the arcuate handle further comprising:
a horizontal bridge and the opposed first and second vertical arms extending from opposite ends of the bridge to the terminal ends, the vertical arms and bridge having outer surfaces and being adapted to hold a filing strip extending between them, the horizontal bridge and vertical arms generally defining a handle plane and having a front surface and a back surface;
first and second sets of partial-cylindrical grip portions distributed along the outer surfaces of the first and second vertical arms, respectively, each of the grip portions extending longitudinally from a first end surface projected outward from the handle front surface to a second end surface projected outward from the handle back surface, each of the grip portions aligned longitudinally normal to the handle plane; and,
each set comprising a first grip portion disposed proximate the vertical arm terminal end, a second grip portion disposed proximate the connection region of the bridge and respective vertical arm, and a plurality of spaced-apart interstitial grip portions distributed between the first and second grip portions.

16. An improved dental filing strip system as in claim 12, the arcuate handle further comprising:
a horizontal bridge and the opposed first and second vertical arms extending from opposite ends of the bridge to the terminal ends, the vertical arms and bridge having outer surfaces and being adapted to hold a filing strip extending between them, the horizontal bridge and vertical arms generally defining a handle plane and having a front surface and a back surface;
first and second sets of partial-cylindrical grip portions distributed along the outer surfaces of the first and second vertical arms, respectively, each of the grip portions extending longitudinally from a first end surface projected outward from the handle front surface to a second end surface projected outward from the handle back surface, each of the grip portions aligned longitudinally normal to the handle plane; and,
each set comprising a first grip portion disposed proximate the vertical arm terminal end, a second grip portion disposed proximate the connection region of the bridge and respective vertical arm, and a plurality of spaced-apart interstitial grip portions distributed between the first and second grip portions.
